(19) United States
(12) Patent Application Publication
(10) Pub. No.: US 2022/0163737 A1
(43) Pub. Date: May 26, 2022

(54) STRAIN RELIEF BOOTS FOR FIBER OPTIC CONNECTORS

(71) Applicant: Corning Research & Development Corporation, Corning, NY (US)

(72) Inventors: Adra Smith Baca, Hickory, NC (US); Ashley Wesley Jones, Denton, TX (US); Nikhil Baburam Vasudeo, Pune (IN)

(21) Appl. No.: 17/527,282

(22) Filed: Nov. 16, 2021

Related U.S. Application Data
(60) Provisional application No. 63/118,234, filed on Nov. 25, 2020.

(51) Int. Cl. G02B 6/38

(52) U.S. Cl. CPC G02B 6/38875; G02B 6/3888

(57) ABSTRACT

Strain relief boots for optic fiber cables are provided. A strain relief boot includes a substrate including a front segment and an opposite rear segment, wherein the substrate includes at least a first material, and a sleeve including a mounting portion and an opposite tail portion, wherein the sleeve includes at least a second material that is less rigid than the first material, the mounting portion of the sleeve engages the rear segment of the substrate, and the substrate and the sleeve are coaxial with one another extending along a portion of a longitudinal axis.

### CROSS-REFERENCE TO RELATED APPLICATIONS

This application claims the benefit of priority of U.S. Provisional Application Ser. No. 63/118,234 filed on Nov. 25, 2020, the content of which is relied upon and incorporated herein by reference in its entirety.

### TECHNICAL FIELD

The present specification generally relates to strain relief boots for preventing bending in excess of a minimum bend radius of a cable and, more specifically, strain relief boots for fiber optic cables and fiber optic connectors.

### BACKGROUND

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. A fiber optic connector typically includes a ferrule with one or more bores that receive one or more optical fibers. The ferrule supports and positions the optical fiber(s) with respect to a housing of the fiber optic connector. Thus, when the housing of the fiber optic connector is mated with another connector, an optical fiber in the ferrule is positioned in a known, fixed location relative to the housing. This allows an optical connection to be established when the optical fiber is aligned with another optical fiber provided in the mating connector.

The housing of a fiber optic connector is often a relatively rigid component so that the fiber optic connector can withstand a variety of forces during handling and use without affecting the optical connection. Having rigid components, however, presents design challenges elsewhere. For example, fiber optic cables upon which fiber optic connectors are installed are typically much less rigid than the fiber optic connectors. The rapid transition from high stiffness to low stiffness may result in stress concentrations where the cable meets the connector. Radial loads applied to the cable may then result in the cable bending beyond a minimum bend radius that must not be exceeded for the cable to function properly.

To address the above-mentioned challenge, a fiber optic connector typically includes a flexible, strain-relieving boot that snaps onto a rigid portion of the fiber optic connector and extends rearwardly over a portion of the cable. The boot provides a transition in stiffness between the fiber optic connector and the cable. Although many different boot designs have been proposed to properly provide this transition, new solutions are still desired. It can be difficult to address conflicting conditions at opposite ends of the boot, namely a high stiffness at the end of the boot coupled to the connector and a low stiffness at the end of the boot terminating on the cable. Failure to do so may result in stress concentration points and kinking that weaken the boot or otherwise still lead to unacceptable bending of the cable. Existing solutions may not adequately address these conflicting conditions, manufacturability challenges, space constraints, and other considerations.

### SUMMARY

In one embodiment, a strain relief boot for a fiber optic cable includes a substrate including a front segment and an opposite rear segment, wherein the substrate includes at least a first material, and a sleeve including a mounting portion and an opposite tail portion, wherein the sleeve includes at least a second material that is less rigid than the first material, the mounting portion of the sleeve engages the rear segment of the substrate, and the substrate and the sleeve are coaxial with one another extending along a portion of a longitudinal axis.

In another embodiment, a strain relief boot for a fiber optic cable includes a substrate including a front segment and an opposite rear segment, wherein the substrate includes at least a first material, and a sleeve including a mounting portion and an opposite tail portion, wherein the sleeve includes at least a second material that is less rigid than the first material, the mounting portion of the sleeve surrounds the rear segment of the substrate defining an overlapping region, the substrate and the sleeve are coaxial with one another extending along a portion of a longitudinal axis, and the sleeve is overmolded onto the substrate.

In yet another embodiment, a strain relief boot for a fiber optic cable includes a substrate including a front segment and an opposite rear segment, wherein the substrate includes at least a first material, and a sleeve including a mounting portion and end opposite tail portion, wherein the sleeve includes at least a second material that is less rigid than the first material, the mounting portion of the sleeve surrounds the rear segment of the substrate, the substrate and the sleeve are coaxial with one another extending along a portion of a longitudinal axis, and the substrate includes a plurality of channels formed at an end of the rear segment and extending parallel to the longitudinal axis to define a plurality of splines.

In yet another embodiment, a fiber optic cable assembly includes a fiber optic cable having at least one optical fiber, a fiber optic connector installed on the fiber optic cable, the fiber optic connector including a housing, and a strain relief boot extending from an end of the housing, the strain relief boot including a substrate including a front segment and an opposite rear segment, wherein the substrate includes at least a first material, and a sleeve including a mounting portion and end opposite tail portion, wherein the sleeve includes at least a second material that is less rigid than the first material, the mounting portion of the sleeve surrounds the rear segment of the substrate, and the substrate and the sleeve are coaxial with one another extending along a portion of a longitudinal axis.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a fiber optic cable assembly including a strain relief boot according to one or more embodiments shown and described herein;

FIG. 2 schematically depicts a cross-sectional view of the optic cable assembly of FIG. 1 without the strain relief boot according to one or more embodiments shown and described herein;

FIG. 3 schematically depicts a cross-sectional view of another embodiment of a strain relief boot according to one or more embodiments shown and described herein;

FIG. 4 schematically depicts a cross-sectional view of another embodiment of a strain relief boot according to one or more embodiments shown and described herein;

FIG. 5 schematically depicts a cross-sectional view of another embodiment of a strain relief boot according to one or more embodiments shown and described herein;

FIG. 6 schematically depicts a perspective view of an embodiment of a substrate of a strain relief boot according to one or more embodiments shown and described herein;

FIG. 7 schematically depicts a partial cross-sectional view of another embodiment of a substrate of a strain relief boot according to one or more embodiments shown and described herein;

FIG. 8 schematically depicts a perspective view of another embodiment of a strain relief boot according to one or more embodiments shown and described herein; and

FIG. 9 schematically depicts a cross-sectional view of the strain relief boot of FIG. 8 according to one or more embodiments shown and described herein.

### DETAILED DESCRIPTION

Embodiments described herein are directed to strain relief boots that prevent a smooth transition from the stiffness from a fiber optic connector to a fiber optic cable, and prevent kinking at ends of the strain relief boot. The strain relief boots comprise a substrate comprising a front segment and an opposite rear segment, wherein the substrate comprises at least a first material. The strain relief boot further comprises a sleeve comprising a mounting portion and an opposite tail portion, wherein the sleeve comprises at least a second material that is less rigid than the first material, the mounting portion of the sleeve engages the rear segment of the substrate, and the substrate and the sleeve are coaxial with one another extending along a portion of a longitudinal axis.

By providing the sleeve having the mounting portion surrounding the rear segment of the substrate, this creates a strain relief boot having a gradually reduced stiffness from the substrate to the sleeve. This resists kinking of the strain relief boot over large temperature ranges in which the strain relief boot is used. This also allows the strain relief boot to maintain a minimum bend radius at the extremes of the temperatures and loads which the stain relief boot experiences.

Various embodiments of the strain relief boots and the operation of the strain relief boots are described in more detail herein. Whenever possible, the same reference numerals will be used throughout the drawings to refer to the same or like parts.

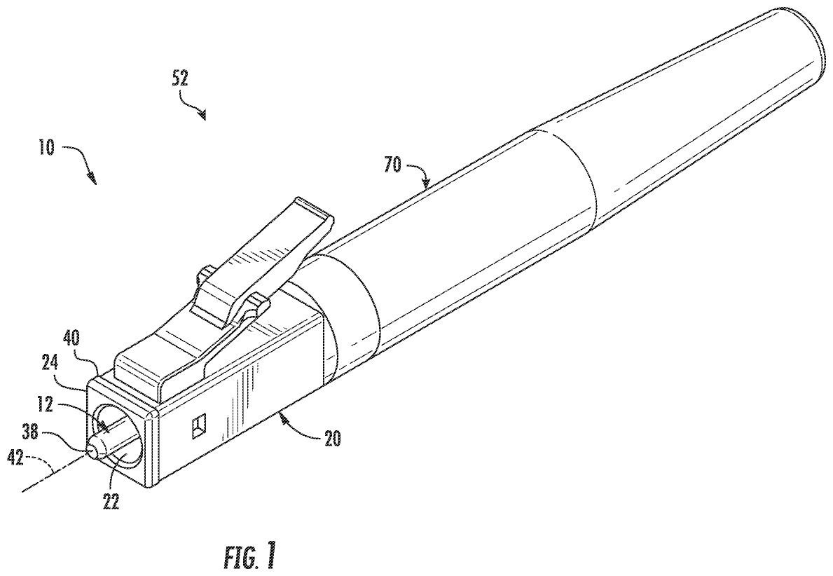

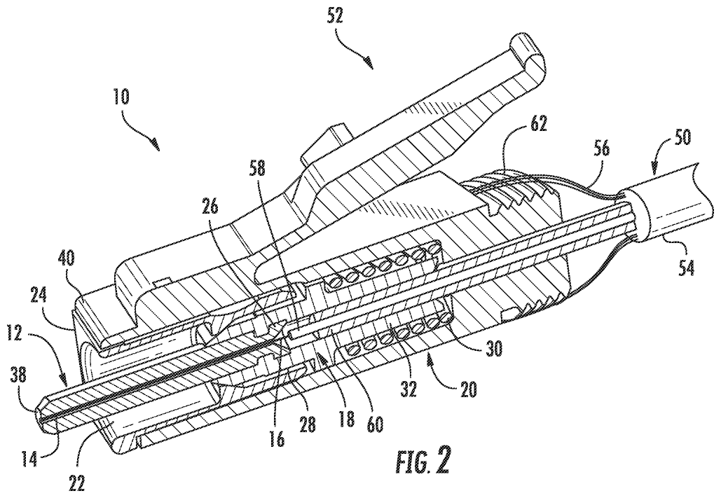

Referring to FIGS. 1 and 2, one non-limiting example of a fiber optic connector 10 is shown. Although the fiber optic connector 10 is shown in the form of a LC-type connector, the features described below may be applicable to different connector designs such as, for example, SC and ST-type connectors, and other single-fiber or multi-fiber connector designs.

In embodiments, as shown in FIGS. 1 and 2, the fiber optic connector 10 includes a ferrule 12 having a ferrule bore 14 configured to support an optical fiber 16, a ferrule holder 18 from which the ferrule 12 extends, and a housing 20 having a cavity 22 in which the ferrule 12 and ferrule holder 18 are received. The ferrule holder 18 is retained within the housing 20 by a cap 24. More specifically, a back end 26 of the ferrule 12 is received in a first portion 28 of the ferrule holder 18 and is secured therein in a known manner such as, for example, press-fit, adhesive, and/or molding the ferrule holder 18 over the back end 26 of the ferrule 12. In embodiments, the ferrule 12 and the ferrule holder 18 form a monolithic structure.

In embodiments, the ferrule holder 18 is biased to a forward position within the housing 20 by a spring 30, which extends over a second portion 32 of the ferrule holder 18 having a reduced cross-sectional diameter/width compared to the first portion 28. The spring 30 also interacts with an internal geometry of the housing 20. The cap 24 is secured to the housing 20 and limits forward movement of the ferrule holder 18, thereby retaining the ferrule holder 18 within the housing 20.

When the fiber optic connector 10 is assembled, as shown in FIG. 1, a front end 38 of the ferrule 12 projects beyond a forward end 40 of the housing 20 and the cap 24. The front end 38 of the ferrule 12 presents the optical fiber 16 for optical coupling with a mating component, for example, another fiber optic connector. The ferrule 12 aligns the optical fiber 16 along a longitudinal axis 42. These aspects can be better appreciated with reference to FIG. 2, which shows how a fiber optic cable 50, referred to herein as a cable 50, including the optical fiber 16 can be terminated with the fiber optic connector 10. In other words, the fiber optic connector 10 can be installed on the fiber optic cable 50 to form a fiber optic cable assembly 52. The fiber optic cable 50, as shown in FIG. 2, is merely an example and other suitable fiber optic cables are within the scope of this disclosure. In the embodiment shown, the cable 50 includes a jacket 54, strength members 56 in the form of aramid yarn, and the optical fiber 16, which itself is surrounded by a coating 58 and a buffer layer 60. Portions of the jacket 54 have been removed from the optical fiber 16 to expose the strength members 56, which are cut to a desired length and placed over a rear portion 62 of the housing 20. The strength members 56, when present, may be coupled to the housing 20 by a strain relief boot 70 (hereafter “boot 70” shown in FIG. 1), as will be discussed below. The boot 70 is configured to at least partially surround a portion of the cable 50 (FIG. 2) where the cable 50 enters the fiber optic connector 10. The boot 70 may be attached to the cable 50, for example by way of connection with the strength members 56, or the boot 70 may “float” around the cable 50.

Variations of these aspects will be appreciated by persons skilled in the design of fiber optic cable assemblies. Reiterating from above, the embodiment shown in FIGS. 1 and 2 is merely an example of a fiber optic connector 10 that may be used in connection with the devices and methods described below. The general overview has been provided simply to facilitate discussion. The present disclosure is also applicable to other types of fiber optic connectors and fiber optic cable assemblies, as well as non-fiber optic cables.

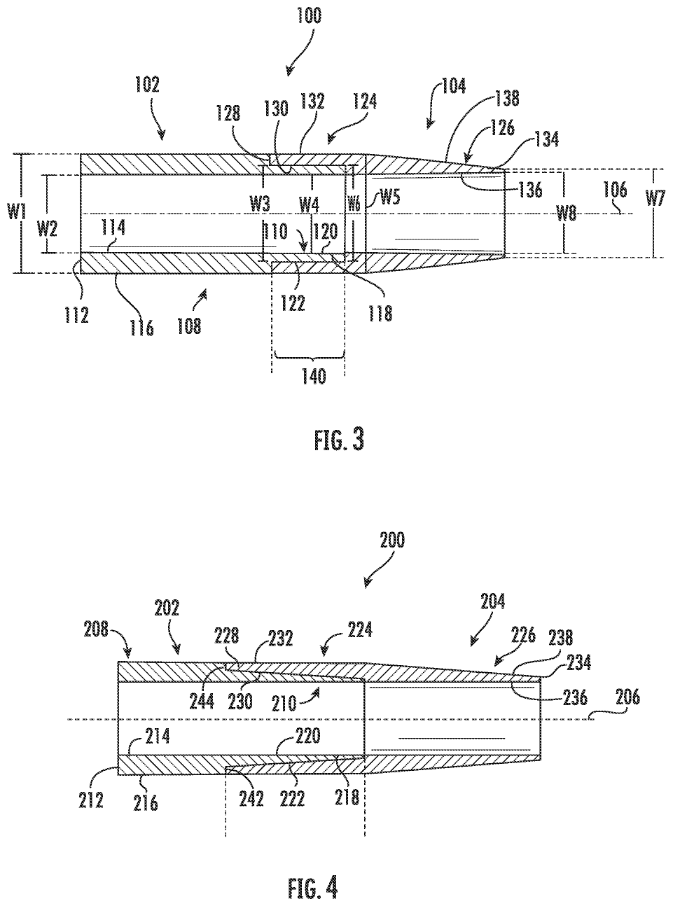

FIG. 3 illustrates an example embodiment of a strain relief boot 100, referred to herein as a boot 100, for the fiber optic connector 10. The boot 100 comprises a substrate 102 fabricated from a first material and a sleeve 104 that at least partially surrounds at least a portion of the substrate 102. The sleeve 104 is fabricated from a second material. The first material used to construct the substrate 102 is more rigid than the second material used to construct the sleeve 104. In this way, the substrate 102 is able to at least partially structurally support the sleeve 104. The boot 100 may be formed by overmolding the sleeve 104 onto the substrate 102 or, in some embodiments, the boot 100 may be a single component formed by injection molding the sleeve 104 and the substrate 102. By molding the sleeve 104 onto the substrate 102, adherence between the substrate 102 and the sleeve 104 may be improved, which may increase the performance of the boot 100 as a whole. As discussed further below, adherence may be supported by intermingling portions of the sleeve 104 with portions of the substrate 102 during or as a result of the molding or overmolding process. In other embodiments, as described herein, the substrate 102 may be press fit into at least a portion of the sleeve 104 or otherwise secured or coupled to the sleeve 104.

The first material from which the substrate 102 may be molded or otherwise fabricated from is a relatively rigid material, such as a relatively rigid, or substantially rigid, polymer. In embodiments, the first material has a Young's modulus of 2.0 to 3.5 gigapascals (GPa). In embodiments, the first material has a Young's modulus of 2.5 to 3.0 GPa. Non-limiting examples of suitable polymers from which the first material may be selected may include polyetherimides sold under the trade name ULTEM™, or polycarbonate such as sold under the trade name LEXAN™. In some embodiments, metals or alloys, such as aluminum, nickel silver, brass, or the like may be used to form the substrate 102.

The substrate 102 may be in the form of a conduit extending along a longitudinal axis 106 that corresponds to the longitudinal axis 42 (FIG. 1). The substrate 102 may include a front segment 108 configured to attach to the fiber optic connector 10, particularly the housing 20 (FIGS. 1 and 2). The substrate 102 also includes a rear segment 110 extending from the front segment 108. The front segment 108 has a peripheral wall 112 with an inner surface 114 and an outer surface 116. The inner surface 114 at least partially defines a lumen through which the cable 50 (FIG. 2) is configured to pass. The front segment 108 has an outer width W1 defined by the outer surface 116 and an inner width W2 defined by the inner surface 114. In the illustrated embodiment, the front segment 108 is cylindrical such that the outer width W1 and the inner width W2 are substantially constant. The maximum outer width W1 may be about or less than about 6.25 mm, about or less than about 6.0 mm, or about or less than about 5.8 mm. Such outer widths W1 have the advantage of keeping the boot 100 sufficiently small to allow the fiber optic connector 10 to be used in common duplex configurations (e.g., LC duplex configuration). In other embodiments, the maximum outer width W1 may be greater than 6.25 mm. Additionally, the front segment 108 is not necessarily limited to cylindrical shapes, and the outer width W1 may taper along the longitudinal axis 106 of the boot 100 when the boot 100 is attached to the fiber optic connector 10. The front segment 108 may also have a transverse cross-sectional profile perpendicular to the longitudinal axis 106 that is or is not circular. The inner width W2 may be approximately 3.9 mm, but is expected to be selected based on the size of the housing 20 or another portion of the fiber optic connector 10 to which the substrate 102 is configured to be attached. It should be understood that the embodiments described herein are not limited by any particular values for the outer width W1 and the inner width W2.

Still referring to FIG. 3, the rear segment 110 of the substrate 102 includes a peripheral wall 118 having an inner surface 120 and an outer surface 122. The outer surface 122 of the rear segment 110 may define an outer width W3, and the inner surface 120 may define an inner width W4. Generally, it is expected that the outer width W1 of the front segment 108 will be greater than the outer width W3 of the rear segment 110. Having an outer width W1 greater than the outer width W3 allows room to accommodate the sleeve 104 around the outside of the rear segment 110, as described in more detail below. The outer width W3 may be any appropriate value. As a non-limiting example, the outer width W3 may be about 4.6 mm in some of the embodiments where the outer width W1 is about or greater than about 5.8 mm. The inner width W2 of the front segment 108 may be greater than, equal to, or less than the inner width W4 of the rear segment 110. As shown, the inner width W2 is equal to the inner width W4. The rear segment 110 may be cylindrical (i.e., having a circular cross section perpendicular to the longitudinal axis 106) or may have a non-circular profile. The outer surface 122 of the rear segment 110 may be un-tapered to provide a consistent outer width W3, or the outer width W3 may taper along the longitudinal axis 106 of the boot 100, as described in more detail herein. It should be appreciated that the length of the substrate 102 is not limited to that illustrated and the length may be adjusted based on a length of the sleeve 104 and a desired minimum bending radius of the cable 50. The length of the substrate 102 and the sleeve 104 are determined based on a finite element analysis at high temperatures and low temperatures such that the boot 100 is supported over a 90 degree bend so as to not impart unrecoverable strain or a kink in the boot 100 or the cable 50 extending through the boot 100.

Still referring to FIG. 3, the sleeve 104 may be in the form of a conduit extending along the longitudinal axis 106 and, thus, coaxial with the substrate 102. The sleeve 104 includes a mounting portion 124, which is configured to attach to the rear segment 110 of the substrate 102, and a tail portion 126 extending from the mounting portion 124. In embodiments, the sleeve 104 may be injection molded or overmolded onto the substrate 102. The sleeve 104 may be molded or otherwise formed from a second material less rigid than the first material forming the substrate 102. Non-limiting examples of suitable polymers from which the second material may be selected may include an elastomer such as thermoplastic polyurethane, polyetherimide, and polycarbonate.

It should be appreciated that both the geometry and the materials selected for the substrate 102 and the sleeve 104 cooperate to control a bending of the boot 100, and thus the cable 50 extending through boot 100, over a large temperature range. In a non-limiting example, at a low temperature, the substrate 102 has a stiffness that reduces bending of the boot 100, but the sleeve 104 remains ductile to allow the cable 50 to bend. Alternatively, at a high temperature, the substrate 102 carries the load and the sleeve 104 is superfluous. At temperatures between the low temperature and the high temperature, both the substrate 102 and the sleeve 104 contribute to the bending of the boot 100.

The mounting portion 124 has a peripheral wall 128 with an inner surface 130 and an outer surface 132. The mounting portion 124 has an outer width W5 defined by the outer surface 132 and an inner width W6 defined by the inner surface 130. The mounting portion 124 may be cylindrical, as shown, (i.e., having a circular cross section perpendicular to the longitudinal axis 106) such that the outer width W5 and the inner width W6 are substantially constant, or may have a non-circular profile corresponding to the profile of the rear segment 110 of the substrate 102. For example, the inner surface 130 may be un-tapered to provide a consistent inner width W6 or the inner width W6 may taper along the longitudinal axis 106 of the boot 100 to correspond to a taper of the outer width W3 of the rear segment 110 of the substrate 102, as described in more detail herein.

The outer width W5 of the mounting portion 124 of the sleeve 104 is configured to be substantially equal with the outer width W1 of the front segment 108 of the substrate 102 to provide a smooth transition along the boot 100 from the substrate 102 to the sleeve 104. A smooth outer surface 132 minimizes the locations along the boot 100 that may be caught while running the cable assembly 52 in a data center or other environment. The outer width W5 of the mounting portion 124 of the sleeve 104 may be constant and have a minimum outer width of about 3.6 mm. The inner width W6 of the mounting portion 124 of the sleeve 104 is configured to be substantially equal to the outer width W3 of the rear segment 110 of the substrate 102. Having an inner width W6 greater than an inner width W8 allows room to accommodate the substrate 102 within the mounting portion 124 of the sleeve 104.

Still referring to FIG. 3, the tail portion 126 of the sleeve 104 includes a peripheral wall 134 having an inner surface 136 and an outer surface 138. The outer surface 138 of the tail portion 126 may have a constant outer width W7, or may be tapered radially inwardly in a direction opposite the mounting portion 124, as shown. Additionally, the inner surface 136 of the tail portion 126 may define an inner width W8. Generally, it is expected that the inner width W4 of the rear segment 110 is equal to the inner width W8 of the tail portion 126 to provide a smooth transition between inner surfaces of the substrate 102 and the sleeve 104.

At no location should the inner width W8 be less than the diameter of the desired cables 50 intended for use with the boot 100. In one non-limiting example, the inner width W8 is large enough to accept a 2.9 mm cable, such as by being about 3.0 mm. The sleeve 104 may be approximately 32.4 mm long. Minimizing the length of the sleeve 104 may be desirable if the desired bend radius control can be maintained. Sleeve lengths of at least between about 30 mm and about 36 mm have been contemplated. The total length of the boot 100, including both the substrate 102 and the sleeve 104, may be about 35.4 mm in one embodiment. However, it should be appreciated that the length of the sleeve 104 is not limited to that illustrated and the length may be adjusted based on the length of the substrate 102 and a desired minimum bending radius of the cable 50.

An overlapping region 140 is defined by an area at which the mounting portion 124 of the sleeve 104 surrounds or otherwise engages the rear segment 110 of the substrate 102. Due to the changes in widths of the substrate 102 and the sleeve 104 within the overlapping region 140, it should be appreciated that a first stiffness of the boot 100 at the front segment 108 of the substrate 102 is greater than a second stiffness of the boot 100 at the overlapping region 140, and the second stiffness is greater than a third stiffness of the boot 100 at the tail portion 126 of the sleeve 104. It should be appreciated that there is a smooth gradient in stiffness between the substrate 102 and the sleeve 104 such that the boot 100 begins having a stiffness at the front segment 108 of the substrate 102 substantially equal to a stiffness at the connector to which the substrate 102 is attached, and terminates with a stiffness at the tail portion 126 of the sleeve 104 having a stiffness substantially equal to a stiffness of the cable 50 extending through the sleeve 104.

Further embodiments of a strain relief boot including a substrate and a sleeve are illustrated and described herein including various configurations for engagement of the substrate and the sleeve. It should be appreciated that the above description is equally applicable to the further embodiments described herein.

With reference to FIG. 4, an example embodiment of a strain relief boot 200, referred to herein as a boot 200, is illustrated including a substrate 202 and a sleeve 204. As with the boot 200 described herein, the substrate 202 includes a front segment 208 and a rear segment 210 extending from the front segment 208. The front segment 208 has a peripheral wall 212 with an inner surface 214 and an outer surface 216. The rear segment 210 also has a peripheral wall 218 with an inner surface 220 and an outer surface 222. Moreover, the sleeve 204 includes a mounting portion 224 and a tail portion 226 extending from the mounting portion 224. The mounting portion 224 has a peripheral wall 228 with an inner surface 230 and an outer surface 232. The tail portion 226 also has a peripheral wall 234 with an inner surface 236 and an outer surface 238.

It should be appreciated that the boot 200 is similar to the boot 100 described herein, except for the outer surface 222 of the rear segment 210 and the inner surface 230 of the mounting portion 224 each having a tapered diameter, unlike the outer surface 122 of the rear segment 110 and the inner surface 130 of the mounting portion 124 of the boot 100 each having a constant diameter. More specifically, the outer surface 222 of the rear segment 210 of the substrate 202 is tapered radially inwardly in a direction opposite the front segment 208 of the substrate 202. The substrate 202 includes a first lateral surface 242 extending perpendicular to a longitudinal axis 206 from the outer surface 216 of the front segment 208 to the outer surface 222 of the rear segment 210 to define a step. Additionally, the inner surface 230 of the mounting portion 224 of the sleeve 204 is tapered radially outwardly in a direction opposite the tail portion 226 of the sleeve 204. Thus, the tapering of the outer surface 222 of the rear segment 210 corresponds to the tapering of the inner surface 230 of the mounting portion 224 such that the rear segment 210 is received within the mounting portion 224 of the sleeve 204. More specifically, a second lateral surface 244 formed at an end of the sleeve 204, extending perpendicular to the longitudinal axis 206, mates with the first lateral surface 242 of the substrate 202 when the sleeve 204 fully engages the substrate 202.

With reference to FIG. 5, an example embodiment of a strain relief boot 300, referred to herein as a boot 300, is illustrated including a substrate 302 and a sleeve 304. As with the boot 200 described herein, the substrate 302 includes a front segment 308 and a rear segment 310 extending from the front segment 308. The front segment 308 has a peripheral wall 312 with an inner surface 314 and an outer surface 316. The rear segment 310 also has a peripheral wall 318 with an inner surface 320 and an outer surface 322. Moreover, the sleeve 304 includes a mounting portion 324 and a tail portion 326 extending from the mounting portion 324. The mounting portion 324 has a peripheral wall 328 with an inner surface 330 and an outer surface 332. The tail portion 326 also has a peripheral wall 334 with an inner surface 336 and an outer surface 338.

It should be appreciated that the boot 300 is similar to the boot 200 described herein, with the addition that the outer surface 322 of the rear segment 310 of the substrate 302 and the inner surface 330 of the mounting portion 324 of the sleeve 304 each includes a locking feature. As described in more detail herein, the locking feature on the substrate 302 mates with the locking feature on the sleeve 304 to more effectively secure the sleeve 304 to the substrate 302.

Specifically, with respect to the substrate 302, the rear segment 310 includes a male locking feature 346 extending radially outwardly from the outer surface 322 of the rear segment 310 of the substrate 302 to form one or more projections. In embodiments, the male locking feature 346 may include a key, a ring extending outwardly from the outer surface 322 of the rear segment 310 of the substrate 302 at least partially around the outer surface 322 about a longitudinal axis 306, a plurality of helical threads, crosscut knurling, and the like. As shown in FIG. 5, the male locking feature 346 includes a plurality of annular rings 348 extending circumferentially around an entire circumference of the outer surface 322 of the rear segment 310.

Similarly, the mounting portion 324 of the sleeve 304 includes a female locking feature 350 extending radially outwardly from the inner surface 330 of the mounting portion 324 of the sleeve 304 to form one or more recesses. In embodiments, the female locking feature 350 may include a keyway, a groove extending radially outwardly from the inner surface 330 of the mounting portion 324 of the sleeve 304 at least partially around the inner surface 330 about the longitudinal axis 306, a plurality of helical mating threads, crosscut knurling, and the like. As shown in FIG. 5, the female locking feature 350 includes a plurality of grooves 352 extending circumferentially around an entire circumference of the inner surface 330 of the mounting portion 324. The female locking features 350 may be formed by overmolding. As shown, the plurality of rings 348 of the male locking feature 346 engage the plurality of grooves 352 of the female locking feature 350 such that the mounting portion 324 of the sleeve 304 is retained on the rear segment 310 of the substrate 302. Although discussed herein as the substrate 302 including the male locking feature 346 and the sleeve 304 including the female locking feature 350, it should be appreciated that, in embodiments, the substrate 302 includes the female locking feature 350 and the sleeve 304 includes the male locking feature 346.

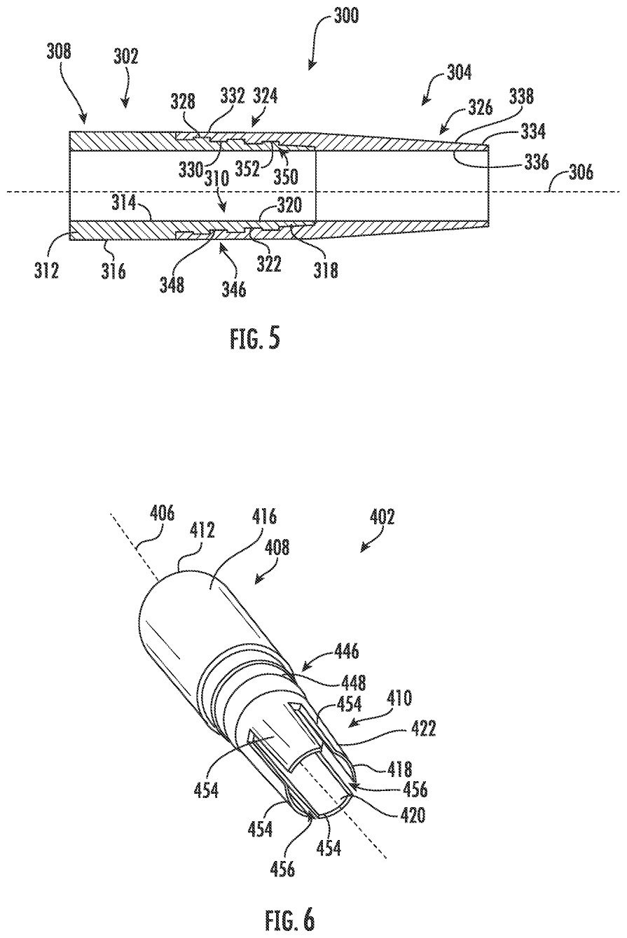

Referring now to FIG. 6, an example embodiment of a substrate 402 of a strain relief boot is illustrated. The substrate 402 is similar to the substrate 302 of the boot 300 described herein such that the substrate 402 includes a front segment 408 and a rear segment 410 extending from the front segment 408. The front segment 408 has a peripheral wall 412 with an inner surface (not shown) and an outer surface 416. The rear segment 410 also has a peripheral wall 418 with an inner surface 420 and an outer surface 422. Additionally, the substrate 402 includes a male locking feature 446 extending radially outwardly from the outer surface 422 of the rear segment 410 of the substrate 402. As shown, the male locking feature 446 of the substrate 402 includes a plurality of rings 448 extending circumferentially around an entire circumference of the outer surface 422 of the rear segment 410.

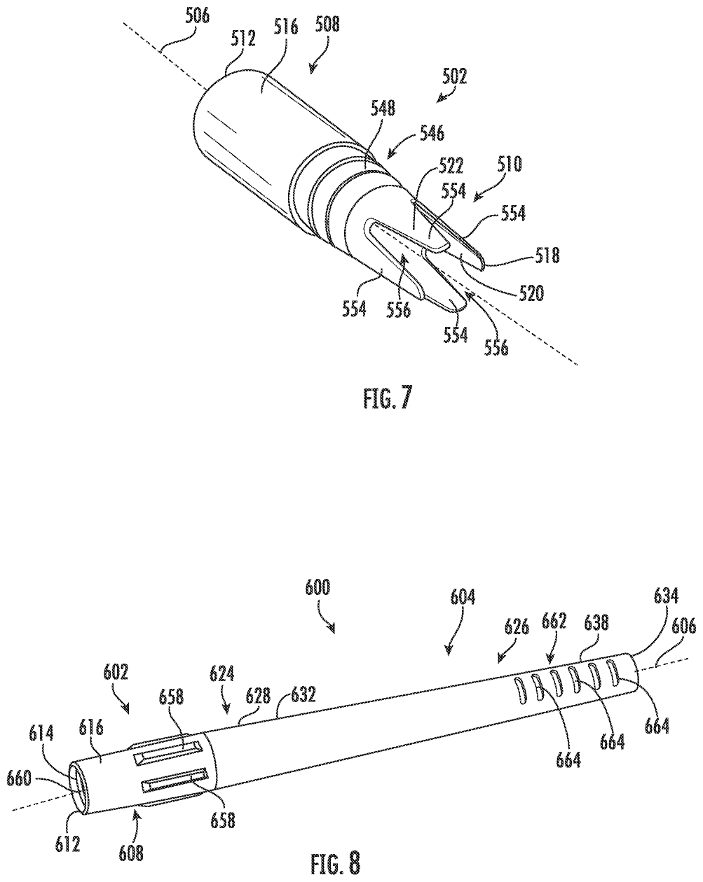

Further, the embodiment of the substrate 402 illustrated in FIG. 7 includes a plurality of splines 454 formed in the rear segment 410 of the substrate 402. Specifically, the rear segment 410 of the substrate 402 has a plurality of channels 456 formed therein and extending parallel to a longitudinal axis 406 from an end of the rear segment 410 toward the front segment 408. Each spline 454 is defined by a pair of adjacent channels 456. Each spline 454 may have a constant width extending tangential to the longitudinal axis 406 and a length extending parallel to the longitudinal axis 406. In embodiments, the width of each spline 454 is constant along the length of the spline 454. However, as discussed in more detail herein, the width of the splines 454 may be tapered. It should be appreciated that by forming the channels 456 in the rear segment 410 of the substrate 402, the amount of material forming the rear segment 410 is further reduced, thereby providing a more gradual transition in stiffness between the substrate 402 and an attached sleeve.

Referring now to FIG. 7, an example embodiment of a substrate 502 of a strain relief boot is illustrated. The substrate 502 is similar to the substrate 402 described herein such that the substrate 502 includes a front segment 508 and a rear segment 510 extending from the front segment 508. The front segment 508 has a peripheral wall 512 with an inner surface (not shown) and an outer surface 516. The rear segment 510 also has a peripheral wall 518 with an inner surface 520 and an outer surface 522. Additionally, the substrate 502 includes a male locking feature 546 including a plurality of rings 548 extending circumferentially around an entire circumference of the outer surface 522 of the rear segment 510, and a plurality of splines 554 formed in the rear segment 510 of the substrate 502 with each spline 554 defined by a pair of adjacent channels 556. However, as shown in FIG. 7, the width of each spline 554 extending tangential to a longitudinal axis 506 is tapered in a direction opposite the front segment 508. Specifically, a width of each spline 554 at an end of the spline 554 closest to the plurality of rings 548 is greater than a width of the spline 554 at an end of the rear segment 510 opposite the plurality of rings 548. By tapering the width of the splines 554 in a direction opposite the front segment 508, the amount of material forming the rear segment 510 is gradually reduced as the boot transitions from the substrate 502 to an attached sleeve, thereby providing a gradual transition in stiffness between the substrate 502 and the attached sleeve.

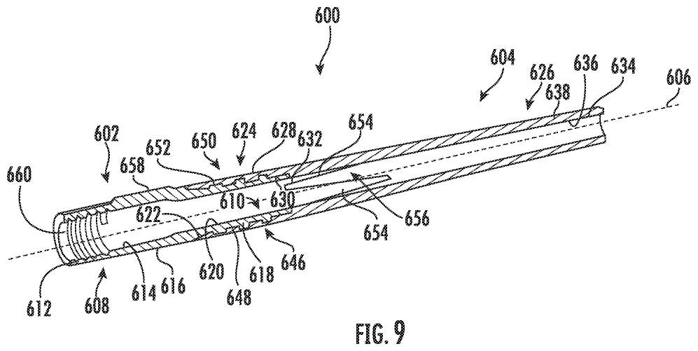

Referring now to FIGS. 8 and 9, an example embodiment of a strain relief boot 600, referred to herein as a boot 600, is illustrated including a substrate 602 and a sleeve 604. The substrate 602 is similar to the substrate 502 described herein such that the substrate 602 includes a front segment 608 and a rear segment 610 extending from the front segment 608. The front segment 608 has a peripheral wall 612 with an inner surface 614 and an outer surface 616. The rear segment 610 also has a peripheral wall 618 with an inner surface 620 and an outer surface 622. Additionally, the substrate 602 includes a male locking feature 646 including a plurality of rings 648 extending circumferentially around an entire circumference of the outer surface 622 of the rear segment 610, and a plurality of splines 654 formed in the rear segment 610 of the substrate 602 with each spline 654 defined by a pair of adjacent channels 656 and tapered in a direction opposite the front segment 608. The sleeve 604 is similar to the sleeve 304 discussed herein and includes a mounting portion 624 and a tail portion 626 extending from the mounting portion 624. The mounting portion 624 has a peripheral wall 628 with an inner surface 630 and an outer surface 632. The tail portion 626 also has a peripheral wall 634 with an inner surface 636 and an outer surface 638. Additionally, the sleeve 604 includes a female locking feature 650 including a plurality of grooves 652 extending circumferentially around an entire circumference of the inner surface 630 of the mounting portion 624.

In the embodiment illustrated, the substrate 602 includes a plurality of protrusions 658 formed on the front segment 608 and extending parallel to a longitudinal axis 606. The protrusions 658 are spaced apart from one another in a circumferential direction on the outer surface 616 of the front segment 608 of the substrate 602. Additionally, the inner surface 614 of the front segment 608 includes one or more helical threads 660 or the like. The threads 660 may assist with attachment of the boot 600 to the fiber optic connector 10 as the boot 600 is installed over the rear portion 62 of the housing 20 (FIGS. 1 and 2), which may include corresponding threads. As such, the boot 600 may be configured to screw onto the fiber optic connector 10. When the cable 50 includes aramid yarns, or similar strength members 56, such as is often found on round cables having a diameter within the range of about 1.6 mm to about 2.9 mm, the aramid yarns may be trapped with the threads 660 against an outside surface of the rear portion 62 of the housing 20. The use of integrated threads 660 within the front segment 608, which are made from a relatively rigid material, may provide yarn capture and the related strain relief without requiring a crimp ring as may be found in some other connectors. When a crimp ring is not present, an installer may be able to complete the cable assembly 52 without the use of a corresponding crimp tool to deform the crimp ring. Nevertheless, in other embodiments, the boot 600 may be used with a connector that includes a crimp ring or other mechanism for securing the cable 50 to the connector.

As shown in FIG. 8, the sleeve 604 includes discontinuities 662 at spaced apart locations along the length of the tail portion 626 and/or at spaced apart locations around the circumference thereof. As shown, the discontinuities 662 are formed proximate an end of the tail portion 626 of the sleeve 604 opposite the mounting portion 624. The presence of the discontinuities 662 reduces the stiffness of the tail portion 626 to enhance or provide at least some ability for bending/flexibility. At the same time, the discontinuities 662 may help to control the maximum degree of bending of the boot 600. In embodiments, the discontinuities 662 are holes in the form of elongated radial slots 664 that extend through the peripheral wall 634 of the tail portion 626. Each of the slots 664 may extend partially around the circumference of the tail portion 626, transverse to the longitudinal axis 606. The slots 664 may control bending when opposite edges of each slot 664 contact one another or become closer to one another as the tail portion 626 is bent. Each slot 664 may extend around more than one-quarter, but less than one-half of the circumference of the tail portion 626. The slots 664 may be arranged in pairs on opposite sides of the circumference of the tail portion 626. An adjacent pair of slots 664 may be rotationally positioned, for example by 90 degrees, around the circumference relative to an initial pair of slots 664. The thicknesses or widths of the slots 664 along the longitudinal axis 606 may be the same, or these dimensions may vary as a function of the location of the slots 664 along the length of the tail portion 626.

Having described the structure of a boot according to a variety of embodiments, some of the functional advantages will now be further described with respect to the boot 600 illustrated in FIGS. 8 and 9 and with reference to the fiber optic connector 10 and cable 50 illustrated in FIGS. 1 and 2. The boot 600 is designed to control a bend radius of the cable 50 where the cable 50 enters the fiber optic connector 10. By controlling the bend radius, attenuation of light can be restricted as the light travels through the cable 50, particularly as light travels through the optical fiber 16. The boot 600 may be configured to be suitable for use with cables 50 across a range of sizes, such as round cables with diameters within the range of approximately 900 μm to approximately 2.9 mm, using the same sized boot. The boot 600 of the present disclosure is configured to provide sufficient stiffness to control bending of larger cables (e.g., 2.9 mm diameter), while being sufficiently flexible to inhibit attenuation of a signal traveling through smaller cables (e.g., 900 μm diameter) at a location where those cables enter the boot 600.

As used herein, the bend radius of the cable 50 adjacent or proximate to the fiber optic connector 10 is sufficiently controlled if the bend radius is maintained sufficiently large to substantially avoid bend-induced attenuation of a signal traveling within the cable 50. The bend radius required for avoiding bend-induced attenuation varies based upon the size and construction of the cable 50 and the optical fiber 16 therein. In some embodiments, maintaining a bend radius greater than or equal to 10 mm is sufficient for most commonly used, commercially-available optical fibers. In other embodiments, maintaining a bend radius greater than or equal to 7 mm is understood to substantially avoid attenuation, such as when a bend-insensitive optical fiber is used. The bend radius is measured when a predetermined cable is tested in accordance with Telecordia GR-326 or related specifications from the International Electrotechnical Commission (IEC). For example, if a 900 μm diameter cable is used, the bend radius is measured adjacent to the exit of the fiber optic connector 10 (e.g., in the region at least partially covered by the boot 600) when a mass weighing 0.5 lbf is supported by the cable 50 as the connector is fixed in a horizontal position. The force of the mass is therefore applied perpendicular to the longitudinal axis 606 of the boot 600. In another example, if a 2.9 mm diameter cable is used, the bend radius is measured adjacent to the exit of the fiber optic connector 10 (e.g., in the region at least partially covered by the boot 600) with a mass of 4.4 lbf loading a portion of the cable so that the cable hangs from a horizontally disposed connector. In some embodiments, the same boot 600 may be able to maintain the bend radius at greater than 10 mm for cables that are as small as 250 μm, or even 125 μm in diameter when used in connection with a 900 μm fan-out/furcation tube.

Another advantage of the boot 600 of the present disclosure may be that the boot 600 is designed to fully function without requiring geometric manipulation. For example, no part of the boot 600 is intended to be removed, added, or deformed by the end user in order for the boot 600 to function as discussed. In another example, and reiterating from above, by integrating threads 660 as part of the boot 600, the boot 600 is able to capture the strength members 56 without requiring the use of a deformed crimp ring. Therefore, connectors 10 having a boot 600 as described herein may have relatively few components, again simplifying assembly and installation. Similarly, by having the boot 600 compatible with a wide range of cable sizes, the boot 600 may be configured to be attached to the fiber optic connector 10, with or without capturing strength members 56, because strength members 56 may not be present in cables 50 of every size within a useful range of the boot 600.

Moreover, the relatively high stiffness of the substrate 602 can be provided without sacrificing a smooth transition in stiffness to the sleeve 604 at the other end of the boot 600. In other words, the boot 600 is still able to transition from a relatively high stiffness at the fiber optic connector 10 to a sufficiently low stiffness at the cable 50 in an acceptable amount of length due to its construction. Thus, within the boot 600 itself, the potential for stress concentrations due to sharp transitions in stiffness between the substrate 602 and the sleeve 604 is reduced/minimized.

From the above, it is to be appreciated that defined herein are embodiments of strain relief boots for fiber optic cables including a substrate fabricated from at least a first material, and a sleeve engaging the substrate, wherein the sleeve is fabricated from a second material that is less rigid than the first material. In embodiments, the substrate of the boot includes a plurality of splines for further transitioning from a greater stiffness at the substrate to a lesser stiffness at the sleeve, thereby reducing the potential for kinking at a connector secured to the substrate and the fiber optic cable extending from the sleeve.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A strain relief boot for a fiber optic cable, the strain relief boot comprising:
a substrate comprising a front segment and an opposite rear segment, wherein the substrate comprises at least a first material; and
a sleeve comprising a mounting portion and an opposite tail portion, wherein:
the sleeve comprises at least a second material that is less rigid than the first material;
the mounting portion of the sleeve engages the rear segment of the substrate; and
the substrate and the sleeve are coaxial with one another extending along a portion of a longitudinal axis.

2. The strain relief boot of claim 1, wherein an outer surface of the front segment of the substrate has a diameter equal to a diameter of an outer surface of the mounting portion of the sleeve.

3. The strain relief boot of claim 1, wherein an outer surface of the rear segment of the substrate is tapered in a direction opposite the front segment of the substrate.

4. The strain relief boot of claim 3, wherein an inner surface of the mounting portion of the sleeve is tapered in a direction opposite the tail portion of the sleeve.

5. The strain relief boot of claim 4, wherein:
the sleeve comprises a female locking feature extending radially outwardly; and
the substrate comprises a male locking feature extending radially outwardly and engaging the female locking feature of the sleeve.

6. The strain relief boot of claim 5, wherein:
the female locking feature comprises a plurality of grooves; and
the male locking feature comprises a plurality of annular rings configured to engage the plurality of grooves.

7. The strain relief boot of claim 5, wherein the male locking feature and the female locking feature each comprises helical threads.

8. The strain relief boot of claim 5, wherein the male locking feature and the female locking feature comprise crosscut knurling.

9. The strain relief boot of claim 4, wherein the substrate comprises a plurality of channels formed at an end of the rear segment and extending parallel to the longitudinal axis to define a plurality of splines.

10. The strain relief boot of claim 9, wherein each of the splines is tapered such that a width of each of the splines tangential to the longitudinal axis increases in a direction toward the front segment of the substrate.

11. A strain relief boot for a fiber optic cable, the strain relief boot comprising:
a substrate comprising a front segment and an opposite rear segment, wherein the substrate comprises at least a first material; and
a sleeve comprising a mounting portion and an opposite tail portion, wherein:
the sleeve comprises at least a second material that is less rigid than the first material;
the mounting portion of the sleeve surrounds the rear segment of the substrate defining an overlapping region;
the substrate and the sleeve are coaxial with one another extending along a portion of a longitudinal axis; and
the sleeve is overmolded onto the substrate.

12. The strain relief boot of claim 11, wherein a first stiffness of the strain relief boot at the front segment of the substrate is greater than a second stiffness of the strain relief boot at the overlapping region, and the second stiffness is greater than a third stiffness of the strain relief boot at the tail portion of the sleeve.

13. A strain relief boot for a fiber optic cable, the strain relief boot comprising:
a substrate comprising a front segment and an opposite rear segment, wherein the substrate comprises at least a first material; and
a sleeve comprising a mounting portion and end opposite tail portion, wherein:
the sleeve comprises at least a second material that is less rigid than the first material;
the mounting portion of the sleeve surrounds the rear segment of the substrate;
the substrate and the sleeve are coaxial with one another extending along a portion of a longitudinal axis; and
the substrate comprises a plurality of channels formed at an end of the rear segment and extending parallel to the longitudinal axis to define a plurality of splines.

14. The strain relief boot of claim 13, wherein the plurality of splines are tapered such that a width of each of the plurality of splines tangential to the longitudinal axis increases toward the front segment of the substrate.

15. The strain relief boot of claim 14, further comprising:
a female locking feature comprising a plurality of grooves; and
a male locking feature comprising a plurality of annular rings configured to engage the plurality of grooves.

16. The strain relief boot of claim 13, wherein the substrate further comprises threads formed on an inner surface of the front segment of the substrate.

17. The strain relief boot of claim 13, wherein the substrate further comprises protrusions formed on an outer surface of the front segment of the substrate.

18. The strain relief boot of claim 17, wherein the protrusions extend parallel to the longitudinal axis and are circumferentially spaced apart from one another.

19. A fiber optic cable assembly comprising:
a fiber optic cable having at least one optical fiber;
a fiber optic connector installed on the fiber optic cable, the fiber optic connector comprising a housing; and
a strain relief boot extending from an end of the housing, the strain relief boot comprising:
a substrate comprising a front segment and an opposite rear segment, wherein the substrate comprises at least a first material; and
a sleeve comprising a mounting portion and end opposite tail portion, wherein:
the sleeve comprises at least a second material that is less rigid than the first material;
the mounting portion of the sleeve surrounds the rear segment of the substrate; and
the substrate and the sleeve are coaxial with one another extending along a portion of a longitudinal axis.

20. The fiber optic cable assembly of claim 19, wherein the fiber optic cable passes through the strain relief boot and has a diameter within the range from about 900 μm to about 2.9 mm, and further wherein the strain relief boot is configured to maintain at least a 10 mm bend radius in the fiber optic cable when the fiber optic cable is subject to at least 0.5 lbf perpendicular to the longitudinal axis.

21. The fiber optic cable assembly of claim 19, wherein an outer surface of the rear segment of the substrate is tapered in a direction opposite the front segment of the substrate.

22. The fiber optic cable assembly of claim 21, wherein an inner surface of the mounting portion of the sleeve is tapered in a direction opposite the tail portion of the sleeve.

23. The fiber optic cable assembly of claim 22, wherein:
the sleeve comprises a female locking feature extending radially outwardly; and
the substrate comprises a male locking feature extending radially outwardly engaging the female locking feature of the sleeve.

24. The fiber optic cable assembly of claim 19, wherein the substrate comprises a plurality of channels formed at an end of the rear segment and extending parallel to the longitudinal axis to define a plurality of splines.

25. The fiber optic cable assembly of claim 24, wherein the plurality of splines are tapered such that a width of each of the plurality of splines tangential to the longitudinal axis increases toward the front segment of the substrate.
